(19) United States
(12) Patent Application Publication
(10) Pub. No.: US 2005/0273407 A1
(43) Pub. Date: Dec. 8, 2005

(54) Methods and apparatus for managing a plurality of investments

(76) Inventors: Richard K. Black, Chicago, IL (US); Rebekah Kohmescher, Chicago, IL (US); Sin Yi Tsai, Naperville, IL (US); Michael C. Walther II, Glencoe, IL (US)

Correspondence Address: James F. Goedken;Bell, Boyd & Lloyd LLC, P.O. Box 1135, Chicago, IL, 60690-1135, US

(21) Appl. No.: 11/056,448

(22) Filed: Feb. 11, 2005

Related U.S. Application Data
(60) Provisional application No. 60/578,145, filed on Jun. 8, 2004.

(51) Int. Cl. G06F 17/60

(52) U.S. Cl. 705/35

(57) ABSTRACT

Methods and apparatus to manage a plurality of investments are disclosed. The methods and apparatus enable an individual investor who is part of an investment group to perform individual transactions as well as group transactions. Each investment transaction made through the investment group is tracked at the transaction level for each investor. The system creates a sub-account within a main investment account for each investor. Each sub-account is associated with its own cost basis regardless of the number of members added or removed from the investment group. In this manner, new members are not buying into built-in gains. Because the present system tracks the transactions at the individual investor level, it can assemble the pieces to provide a report at any level.

### RELATED APPLICATIONS

This non-provisional application claims priority to and the benefit of provisional application 60/578,145 filed Jun. 8, 2004 the entire contents of which are incorporated herein.

### TECHNICAL FIELD

The present disclosure relates in general to investment tracking and reporting, and, in particular, to methods and apparatus for managing a plurality of pooled investments based on individual sub-accounts associated with the pooled account.

### BACKGROUND

Multiple investors, whether individuals or organizations, may combine their money and invest together as a group. These investments are typically referred to as “pooled” investments because investors pool together what would otherwise be separate investments. In other words, a pooled investment or investment portfolio may be owned by multiple entities, such as individual investors and/or other groups of investors and/or organizations. One example of pooled investing is individual family members who form an investment partnership or company which aggregates the family members' money and invests the combined money in an investment portfolio.

These investment groups allow funds to be managed more efficiently. As a result, management fees are reduced and additional investment opportunities are created. For example, a mutual fund is a type of investment group. The mutual fund may include 100,000 shares of company A, 200,000 shares of company B, and 300,000 shares of company C. If an individual investor owns 1% of this example mutual fund, that investor effectively or in one sense owns 1,000 shares of company A, 2,000 shares of company B, and 3,000 shares of company C.

Tracking and reporting on these investment groups is important for a wide variety of reasons. In particular, tax liabilities must be computed for any gains associated with an investment group. Computer software packages are available that attempt to keep track of and report on investment groups. However, existing computer software packages do not track the investment activity of an investment group from the “bottom up” using specific identification at the transaction level. Instead, the existing software packages track the investment group custodial accounts and attempt to allocate ownership of the assets in a “top down” manner using allocation percentages in some fashion. For example, if three investors own equal portions of an investment group, and the investment group owns 100 shares of IBM, then each investor owns 33.33 shares of IBM.

Such pro rata methods of tracking and reporting on investment groups may not effectively and accurately reflect each individual's investments and performance. For example, if a member joins the investment group after securities held by that group have achieved gains (or losses), the new member is buying into built-in gains (or losses). This puts as tax burden (or advantage) on the new member that is not equitable to the new member (or the original members).

In addition, pro rata methods of tracking and reporting on investment groups do not allow different members of the investment group to own different ratios of securities. For example, if an investment group owns 200 shares of company A and 100 shares of company B, then every member of that investment group (regardless of the member's ownership percentage) owns twice as many shares of company A as company B. This does not allow different investment strategies to be executed by different members of the same investment group.

Accordingly, a need exists to improve investment tracking and reporting, particularly investment tracking and reporting for members of an investment group.

### SUMMARY

The methods and apparatus (i.e., the system) disclosed herein tracks each investment transaction made through an investment group, (for example, a partnership or limited liability company) at the transaction level for each investor (for example, partner or member). Instead of taking the total of an investment transaction and allocating to individual investors based on fixed percentages of ownership, the present system specifically identifies the portion of the transaction (e.g., buy, sell, cost basis, dividend payout, or fee payment) allocable to each investor and tracks the individual allocations.

To track an investment group in this manner, the system creates a sub-account for each investor. The sub-accounts associated with a particular investment group total to the main investment account. The main investment account may be located at a third party custodian (e.g., a bank). The present system can maintain these sub-accounts and reconcile them to the total account as desired, such as on a daily basis.

The system allocates assets to each individual based on their individually tracked sub-account, just as if their sub-account was truly an individually managed account. Thus, if a money manager associated with an investment group purchases stock with 5% of the cash in the investment group's account, the investment system records this purchase as if 5% of the cash in each individual sub-account was used to purchase the stock. The system also allocates a number of shares of stock to each individual sub-account that corresponds to the amount of money from the particular sub-account used to purchase the stock. Similarly, the system may allocate investment group expenses to the individual sub-accounts based on the number of shares of stock allocated to the respective sub-accounts.

When a new member is added to an investment group or an existing member is removed from an investment group, the system makes certain adjustments to the accounts associated with all of the other members of that investment group. As described in more detail below, these adjustments must take into account the basis associated with each member and each lot of securities so that adding or removing a member does not affect the original or remaining members of the investment group. Specifically, no member is given any tax advantage or disadvantage when the membership roster changes for an investment group.

Because the present system tracks the transactions at the individual investor level, it allows different members of the investment group to own different ratios of securities. In addition, the system can assemble the pieces to provide a desired report at any level. Examples of reports include reports of holdings, realized and unrealized gains and losses, and income and deduction (fees paid) information, as well as performance reporting, at any level for any investor or investors in the investment group.

In one embodiment, the method of managing a plurality of investments comprises recording data indicative of a first investor identity (e.g., Ann), and recording data indicative of a second investor identity, the first investor identity being different then the second investor identity (e.g., Bob). In addition the method comprises associating data indicative of a first number of shares of a first marketable asset with the data indicative of the first investor identity (e.g., Ann has 100 shares of IBM). In addition the method comprises associating data indicative of a second number of shares of the first marketable asset with the data indicative of the second investor identity, the second number of shares divided by the first number of shares defining a first ratio (e.g., Bob has 200 shares of IBM; First Ratio=2). In addition the method comprises associating data indicative of a third number of shares of a second marketable asset with the data indicative of the first investor identity, the second marketable asset being different then the first marketable asset (e.g., Ann has 100 shares of MSFT). In addition the method comprises associating data indicative of a fourth number of shares of the second marketable asset with the data indicative of the second investor identity, the fourth number of shares divided by the third number of shares defining a second ratio, the second ratio being different than the first ratio (e.g., Bob has 300 shares of MSFT; Second Ratio=3). In addition the method comprises selling the first number of shares of the first marketable asset and the second number of shares of the first marketable asset together as a first pooled group (e.g., Sell all 300 shares of IBM (Ann's 100 and Bob's 200)). In addition the method comprises purchasing a fifth number of shares of a third marketable asset and a sixth number of shares of the third marketable asset together as a second pooled group, the third marketable asset being different than the first marketable asset, the sixth number of shares divided by the fifth number of shares defining a third ratio, the third ratio being equal to the first ratio (e.g., Buy 600 shares (200+400) of APPL; Third Ratio=2). In some embodiments the method further comprises selling the fifth number of shares of the third marketable asset without selling the sixth number of shares of the third marketable asset (i.e., Allow individual transactions in addition to pooled transactions).

### BRIEF DESCRIPTION OF THE DRAWINGS

FIG. 1 is a high level block diagram of a communications system.

FIG. 2 is a more detailed block diagram showing one example of a client device.

FIG. 3 is a more detailed block diagram showing one example of a tracking and reporting server embodying the present system.

FIG. 4 is a flowchart of an example process to manage a plurality of investments according to one embodiment of the present methods and apparatus.

FIG. 5 is a flowchart of an example process to add a member to or remove a member from an investment group according to one embodiment of the present methods and apparatus.

FIG. 6 is a series of tables showing an example investment group with a changing membership according to one embodiment of the present methods and apparatus.

### DETAILED DESCRIPTION OF EXEMPLARY EMBODIMENTS

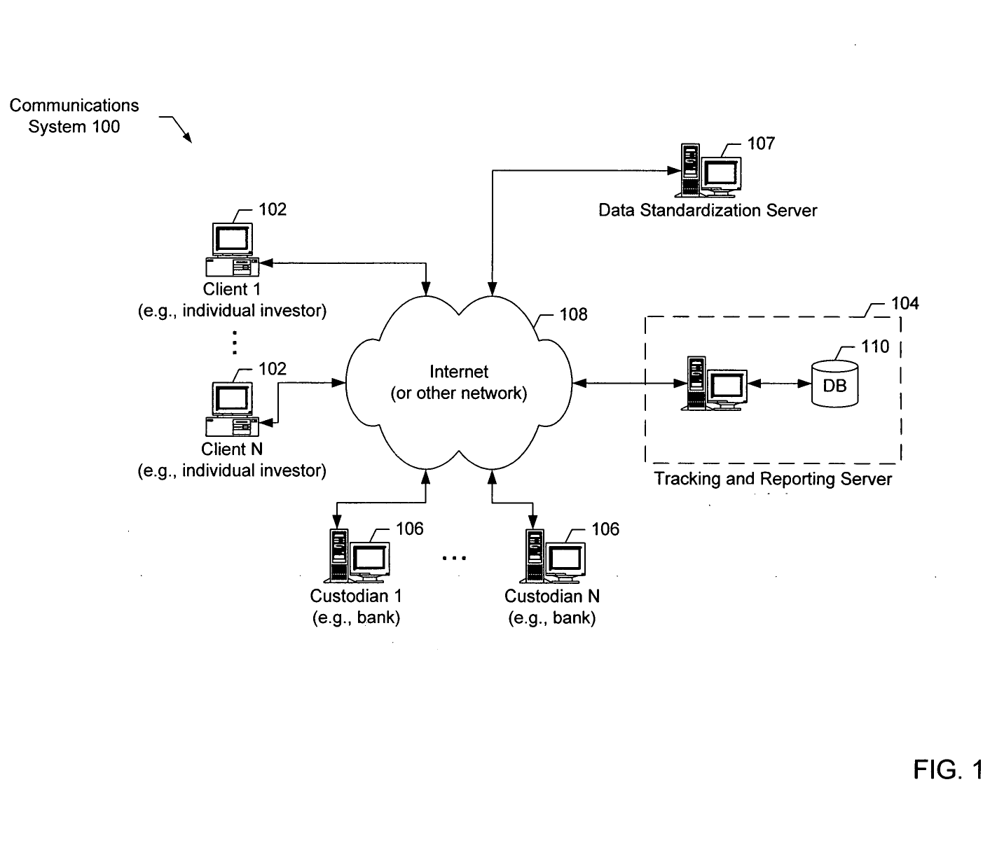

The present system (i.e., methods and apparatus) is most readily realized in a network communications system. A high level block diagram of an exemplary network communications system 100 is illustrated in FIG. 1. The illustrated system 100 includes one or more client devices 102, one or more money manger servers 104, one or more custodian computers 106, and one or more data standardization servers 107. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The tracking and reporting server 104 stores a plurality of files, programs, and/or web pages in one or more databases 110 for use by the clients 102. The databases 110 may be connected directly to the tracking and reporting server 104 and/or via one or more network connections. The databases 110 store client information used by the tracking and reporting server 104 to track and report on pooled financial investments. This tracking and reporting is performed by the tracking and reporting server 104 on an individual basis.

One server 104 may interact with a large number of clients 102. Accordingly, each server 104 is typically a high end computer with a large storage capacity, one or more fast microprocessors, and one or more high speed network connections. Conversely, relative to a typical server 104, each client device 102 typically includes less storage capacity, a single microprocessor, and a single network connection.

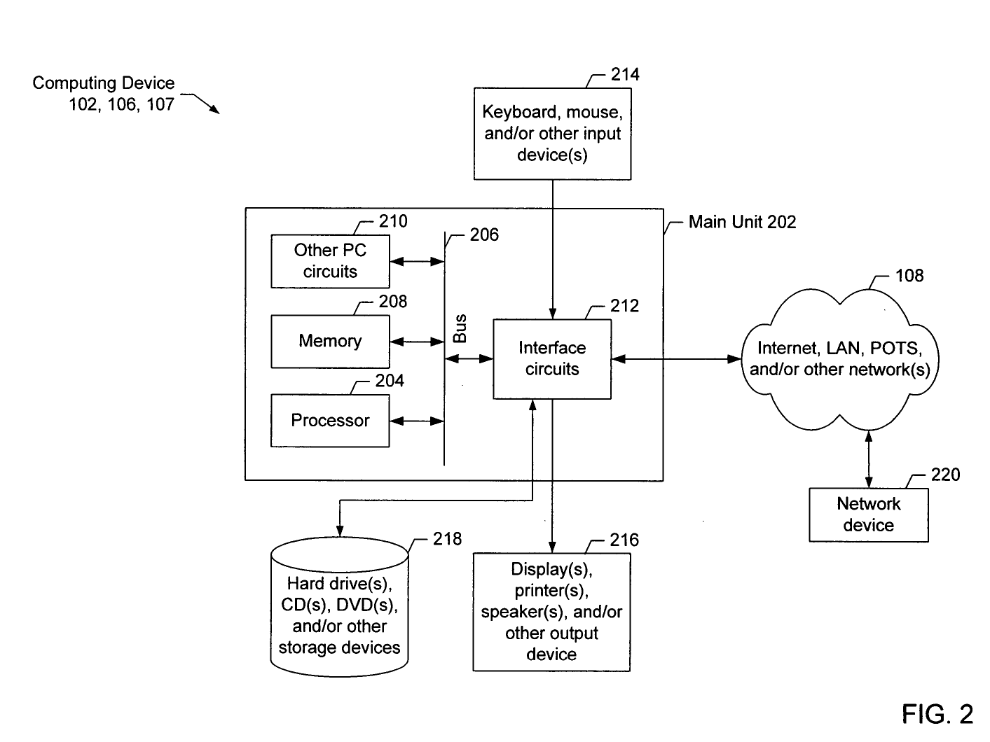

A more detailed block diagram of a client device 102 is illustrated in FIG. 2. The client device 102 may include a personal computer (PC), a personal digital assistant (PDA), an Internet appliance, a cellular telephone, or any other suitable communication device. The client device 102 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with the other devices in the system 100 as described below. This program may be executed by the processor 204 in any suitable manner. The memory 208 may also store digital data indicative of documents, files, programs, web pages, etc. retrieved from a server 104, a custodian computer 106, a standardization server 107 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of suitable display. The display 216 generates visual displays of data generated during operation of the customer computer 102. For example, the display 216 may be used to display web pages received from the server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other suitable storage devices may be connected to the main unit 202. The storage devices 218 may store any type of data used by the customer computer 102.

The client device 102 may also exchange data with other network devices 220 via a connection to the network 108. The network connection may be any type of suitable network connection, such as an Ethernet connection, digital subscriber line (DSL), telephone line, coaxial cable, etc. Users of the system 100 may be required to register with the server 104. In such an instance, each user may choose a user identifier (e.g., e-mail address) and a password which may be required for the activation of services. The user identifier and password may be passed across the network 108 using encryption built into the user's browser. Alternatively, the user identifier and/or password may be assigned by the server 104.

Clients may connect to the server 104 to access data and view or generate reports. Access to the server 104, databases and reports can be controlled by appropriate security software or security measures. An individual member's access can be defined in the system and limited to certain data, information and reports. Access to non-authorized data, information and reports, such as another individual's investment information or aggregated investment information, can be prohibited.

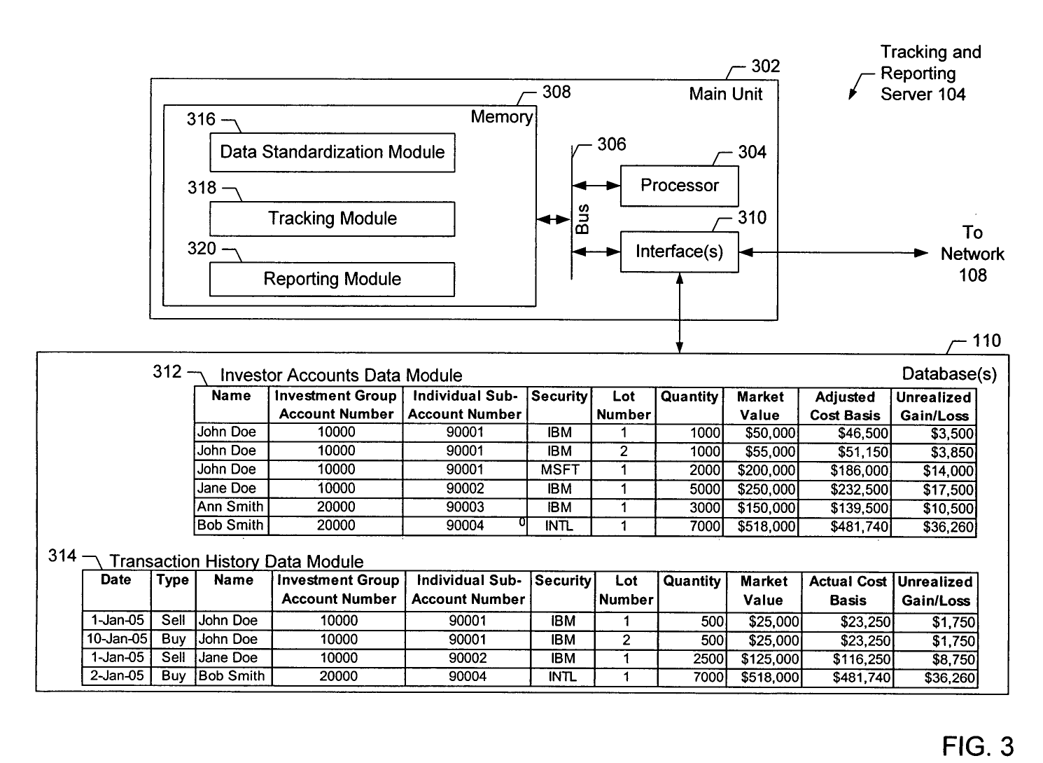

A more detailed block diagram of a server 104 is illustrated in FIG. 3. Like the client device 102, the main unit 302 in the server 104 preferably includes a processor 304 electrically coupled by an address/data bus 306 to a memory device 308 and a network interface circuit 310. The server 104 may exchange data with other devices via a connection to the network 108. The network interface circuit 310 may be implemented using any suitable data transceiver, such as an Ethernet transceiver. The network 108 may be any type of suitable network, such as a local area network (LAN) and/or the Internet.

The processor 304 may be any type of suitable processor, and the memory device 308 preferably includes volatile memory and non-volatile memory. Preferably, the memory device 308 stores computer code or a software program that implements all or part of the methods described below. This program may be executed by the processor 304 in any suitable manner. However, some of the steps described below in connection with the methods may be performed manually and/or without the use of the server 104. The memory device 308 and/or a separate database 110 also store files, programs, web pages, etc. for use by client device 102, other servers 104, custodian computers 106, and/or a standardization server 107.

More specifically, the memory device 308 and/or the database(s) 110 preferably include a plurality of modules 312-320 which determine the overall functionality of the server 104. Each module includes a set of computer readable instructions and/or data which are related to a designated subject matter, topic or purpose. This type of modular construction of the server 104 can be created using any suitable computer programming language and/or database, including, without limitation, JAVA, C++, SQL, etc. Although certain example modules 312-320 are described herein, it should be appreciated that the modules 312-320 of the server 104 may be structured in other ways including as a single module. In such a case, the single module would have the functionality of the separate modules illustrated in FIG. 3.

In the illustrated example, the database(s) 110 include an investor accounts data module 312 and a transaction history data module 314. The illustrated memory device 308 includes a data standardization module 316, a tracking module 318, and a reporting module 320.

The investor accounts data module 312 stores data at the individual investor level. The investor accounts data module 312 may store the investor name, the investment group associated with the investor, the sub-account associated with the investor, each security held by the investor (including the quantity, market value, original cost basis, adjusted cost basis, unrealized gain/loss, etc.), and/or any other data associated with an investor. For example, the first entry in the example investor accounts 312 of FIG. 3 shows 1000 shares of IBM held by John Doe.

John Doe is a member of an investment group identified by account number 10000. This account number may be the actual account number associated with a third party, such as a bank. Jane Doe is also a member of the investment group 10000. However, John Doe's assets are tracked separately from Jane Doe's assets by using the sub-account numbers (i.e., 90001 for John Doe and 90002 for Jane Doe). Preferably, these sub-account numbers are internal to the money manger. In this manner, the Doe family account can be treated as a single account (i.e., account 10000), and/or as individual accounts (i.e., accounts 90001 and 90002). It will be appreciated that members of the same master account need not be actual family members.

When a family account (i.e., an investment group) is treated as a single investment group account, the transactions are still recorded at the individual investor level. For example, if the Doe account sells 50% of its IBM shares, John's quantity will be reduced to 500, and Jane's quantity will be reduced to 2500. Accordingly, the appropriate amount of cash is then added to each account. Allowing treatment as a single investment group account benefits from achieving fee reductions, satisfying money manager minimum requirements, and aggregated reporting. In addition, John Doe may choose to sell some portion of his IBM shares on his own. In such an instance, the shares sold are removed from his account only, and the resulting cash added to his account only. Simultaneously allowing treatment as an individual account allows for flexibility when group participants are not in agreement as to a particular investment strategy (e.g., one member needs some cash while other members do not).

Whenever a transaction occurs (at the group or individual level) the transaction history data module 314 stores data related to the transaction. The transaction history data module 314 may store the date of the transaction, the type of transaction (e.g., buy or sell), the investor name, the investment group associated with the investor, the sub-account associated with the investor, the security bought or sold (including the quantity, market value, cost basis, unrealized gain/loss, etc.), and/or any other data associated with a transaction. For example, the first entry in the example transaction history 314 of FIG. 3 shows 500 shares of IBM sold by John Doe. The second entry in the example transaction history 314 of FIG. 3 shows 2500 shares of IBM sold by Jane Doe

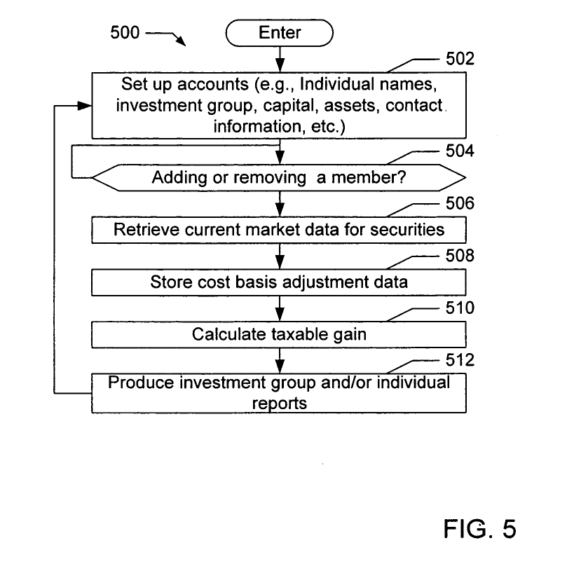

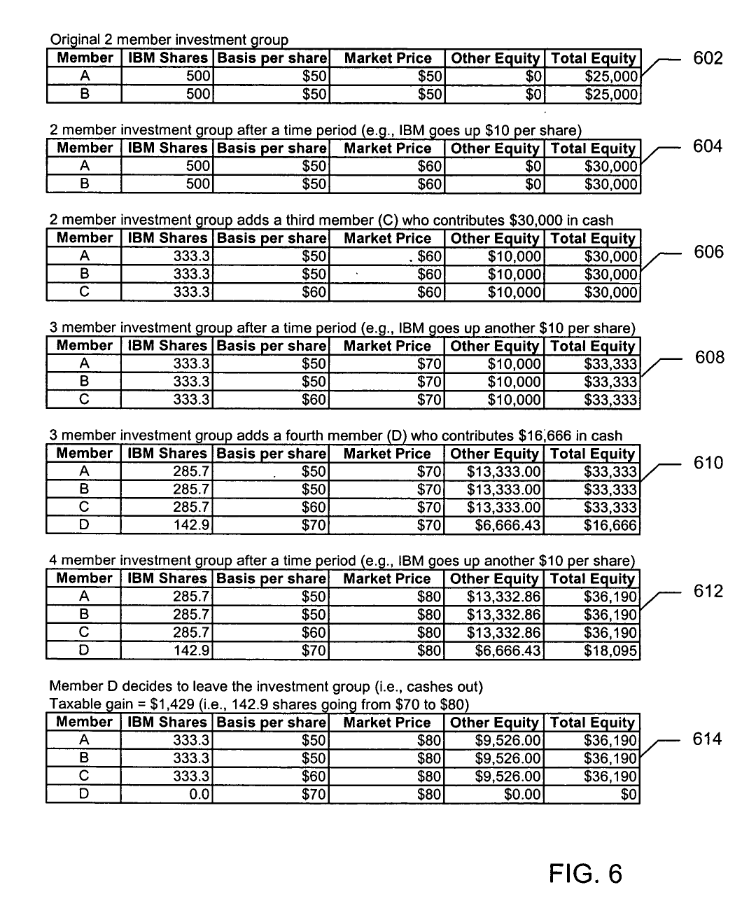

When making contributions, each new dollar invested by an investor, such as a partner or member, may need to be invested over the spectrum of investments in the account, rather than into the next new investment the money manager is purchasing. As described in more detail below with reference to FIG. 5 and FIG. 6, when a new member is added to an investment group each of the existing members effectively sells the new member a portion of their securities. The sale price is preferably based on the current market value of the securities, not the price the securities were originally purchased at. For example, assume an investment group with two equal members holds 1000 shares of IBM that were purchased in a single lot at $50 per share (i.e., $50,000 total). This investment group wants to add a third member who has $25,000 to contribute.

Rather than giving the new member a one-third portion of an entity that now holds $50,000 in stock and $25,000 in cash, the present system automatically checks the current market value of the investment group's assets and calculates each members proportion based on the current market value. For example, if the current price of IBM stock is $60 per share, then the current value of the investment groups assets (before adding the new member) is $60,000 (not $50,000). Accordingly, the new member's $25,000 only gets him a 29.4% share in the new three member investment group (i.e., 25000/(60000+25000)).

However, this share is not accounted for as percentage of the total (i.e., top down). Instead, each member's portion of the investment group is tracked in an individual sub-account (i.e., bottom up). In this example, each of the original members would effectively sell a portion of his/her shares to the new member for the current market price of $60 per share. However, no stock would actually change hands. The gain for each of the original members would remain unrealized until the shares are actually sold on behalf off the entire investment group by the custodian 106.

In order to record each transaction, the data associated with the transaction is preferably standardized. The data standardization module 316 takes financial transaction data in a plurality of different formats and converts the data to a standard format. The investment transaction data can be obtained from various sources, including electronic and manual sources. For example, investment data obtained from one or more commercially available portfolio reporting software and data downloading services can be used. For example, the data standardization module 316 may take data in the format used by each custodian 106 (e.g., bank) and convert the data into a standard format.

Alternatively, the data standardization module 316 may simply receive financial transaction data in a standard format from a third party standardization provider. For example, the custodians 106 may upload all of their transactions to the data standardization server 107 each day. These uploads are in different formats (e.g., each bank uses its own proprietary format). The data standardization server 107 then converts the uploaded data to a standard format, and, the data standardization module 316 interfaces with the data standardization server 107 to receive the standardized financial data.

The tracking module 318 then records these transactions in the transaction history data module 314. For example, the data standardization module 316 may receive a transaction indicating that John Doe sold 500 shares of IBM. Subsequently, the tracking module 318 stores this information in the transaction history data module 314 as shown. In this manner, the server 104 tracks the investments of the entire investment group from the bottom up rather than the top down (i.e., transactions are tracked at the individual investor level).

The reporting module 320 generates reports. For example, the reporting module 320 may generate reports which are specific to a particular investor and/or reports for an investment group. The reports can be customized (e.g., creating reports which contain certain data or are in a format most useful to a particular investor) on an investor by investor basis. The present system can also provide the feature of tracking and reporting tax related information to the proper tax paying investor. Tax related information (such as, realized gains/losses, interest/dividend income, investment fees paid) can be generated in a report. The system can further provide for tracking of and reporting on potential alternative investments. This may allow for evaluating various “what if” scenarios.

In addition, the server 104 may include or interact with other systems, such as a general ledger systems or a tax related systems. For example, the server 104 may produce a delimited (e.g., tab or comma delimited) data file for importing into an accounting software program. Similarly, the server 104 can be combined with a general ledger system and/or a system for tracking private equity investments which would allow for an investment group to outsource its portfolio accounting and investment performance reporting functions.

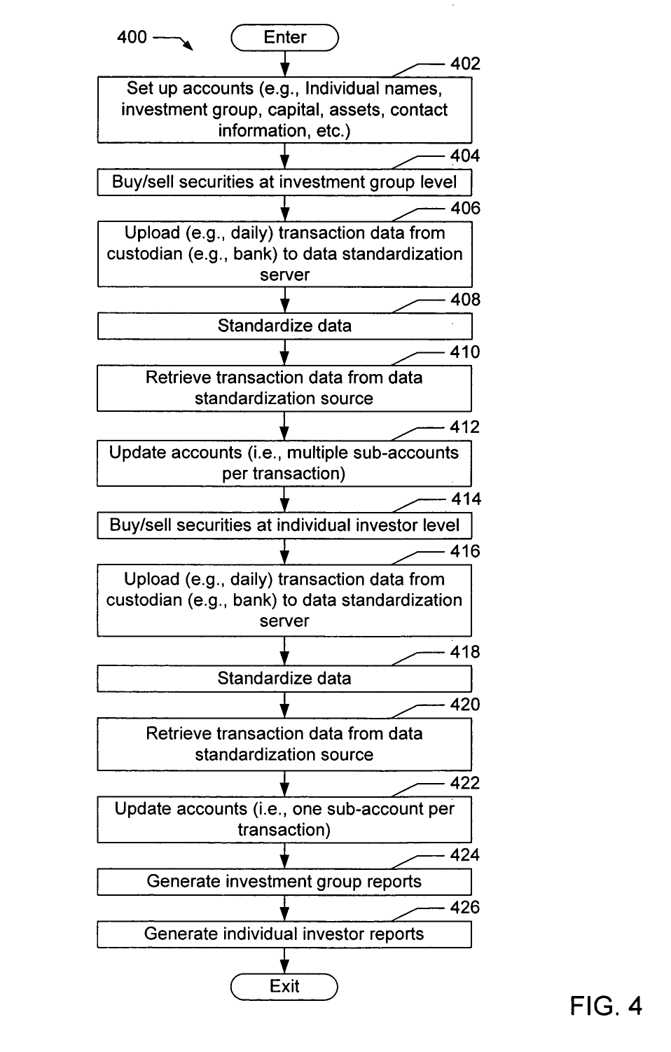

A flowchart of an example process 400 for managing a plurality of pooled investments based on individual sub-accounts is illustrated in FIG. 4. Preferably, the process 400 is embodied in one or more software programs which is stored in one or more memories and executed by one or more processors. Although the process 400 is described with reference to the flowchart illustrated in FIG. 4, it will be appreciated that many other methods of performing the acts associated with process 400 may be used. For example, the order of many of the steps may be changed, and many of the steps described may be optional.

Generally, the process 400 captures financial transactions at the investment group and individual investor level and records those transactions at the individual level. After the data is captured at the individual level, various data and reports may be generated.

The process 400 begins by establishing a plurality of investor accounts as indicated in block 402. For example, data indicative of each investor's name, one or more investment groups, capital, assets, contact information, etc. is preferably stored in a database. Although this portion of the process 400 is shown at the beginning of the process 400 for simplicity, it will be appreciated that new accounts may be added, and existing accounts may be modified or deleted, at any time as described below with reference to FIG. 5.

As investment groups buy and/or sell securities as indicated in block 404, the transaction data is captured by the custodians 106. For example, a bank handling a group account may execute a trade on behalf of the group. Data indicative of the transaction is then sent to a data standardization server 107 as indicated in block 406. For example, each custodian 106 may upload transaction data to the data standardization server 107 on a daily basis. However, the uploaded data is typically in a variety of proprietary formats (e.g., each bank's own format). The data standardization server 107 then converts the uploaded data to a standard format as indicated in block 408.

This standardized data is then retrieved by the money manger server 104 with the investment group's permission as indicated in block 410. The money manger server 104 may then record the transactions in the transaction data history module 314 and/or update the data in the investor accounts data module 312 as indicated in block 412. Because this is a group transaction (as opposed to an individual transaction), multiple sub-accounts are updated at the money manger server 104. For example, if the Doe account sells 50% of its IBM shares, John's quantity will be reduced to 500, and Jane's quantity will be reduced to 2500 even though the Doe account from the custodian's perspective simply went from a total of 6000 shares to a total of 3000 shares.

Similarly, as individual investors (who are also members of groups) buy and/or sell securities (as indicated in block 414), the transaction data is captured by the custodians 106. For example, a bank handling the group account may execute a trade on behalf of an individual. Data indicative of the transaction is then sent to the data standardization server 107 as indicated in block 416. Again, the uploaded data is typically in a proprietary format. Accordingly, the data standardization server 107 converts the uploaded data to a standard format as indicated in block 418.

This standardized data is then retrieved by the money manger server 104 with the investor's permission as indicated in block 420. The money manger server 104 may then record the transaction in the transaction data history module 314 and/or update the data in the investor accounts data module 312 as indicated in block 422. However, because this is an individual transaction (as opposed to a group transaction), only one sub-account is updated at the money manger server 104 for each transaction. For example, John Doe may choose to sell some portion of his IBM sharers on his own. In such an instance, the shares sold are removed from his sub-account only.

At any time, the money manger server 104 may generate a plurality of different reports. For example, the server 104 may generate reports at the investment group level as indicated in block 424 and/or at the individual investor level as indicated in block 426. Reports at the investment group level are based on investment group account numbers. Reports at the individual investor level are based on individual sub-account numbers. In this manner, any number of different levels may be tracked and reported. For example, an investor may be part of one investment group which is part of another investment group. The larger investment group made be made up of other investment groups and/or other individuals. Similarly, an investor may belong to a plurality of different investment groups.

A flowchart of an example process 500 for adding and removing members of an investment group is illustrated in FIG. 5. Preferably, the process 500 is embodied in one or more software programs which is stored in one or more memories and executed by one or more processors. Although the process 500 is described with reference to the flowchart illustrated in FIG. 5, it will be appreciated that many other methods of performing the acts associated with process 500 may be used. For example, the order of many of the steps may be changed, and many of the steps described are optional. Generally, the process 500 records adjustment data associated with the cost basis of securities held by an investment group. As a result, adding and removing members from an investment group is tracked in an equitable manner.

The process 500 begins by establishing a plurality of investor accounts as indicated in block 502. For example, data indicative of each investor's name, one or more investment groups, capital, assets, contact information, etc. is preferably stored in a database. Next, if a member is being added to the investment group (as indicated in block 504) or removed from the investment group (as indicated in block 504), the system retrieves the current market price of each of the affected securities (as indicated in block 506). For example, if the investment group holds one lot of IBM stock that was purchased at $50 per share, another lot of IBM stock that was purchased at $55 per share, and the current price is $60 per share, these built-in gains are preferably accounted for when bringing a new member into the investment group. In this manner, tax liabilities are fairly distributed to the members who actually realize the gains.

In order to account for built-in gains (or losses), the system preferably stores cost basis adjustment data as indicated in block 508. The cost basis adjustment data may be stored in any suitable manner. For example, the market price and quantity of every transaction may be recorded. Transactions include actual buys and sells of securities as well as recorded redistributions resulting from adding or removing members. Alternatively, basis adjustments may be stored as adders (or subtractors) from the actual cost basis for each member.

At any time, the system may calculate the taxable gain (as well as many other data points) associated with the investment group as a whole and/or for each individual member as indicated in block 510. This data may then be produced for the members in the form of a report as indicated in block 512. Reports may be human readable reports (e.g., tables and graphs) or machine readable reports (e.g., tab delimited data for importing into another software program).

FIG. 6 is a series of tables showing an example investment group with a changing membership. In this example, the investment group begins with 2 members as indicated in block 602. Each of the two members is associated with 500 shares of IBM, which was purchased for $50 per share. This gives each member an equity position valued at $25,000. After some period of time, the market price for IBM increases to $60 per share as indicated in block 604. As a result, each member now has $30,000 in equity.

At this point in time, a third member is added as indicated in block 606. The third member is willing to contribute $30,000 in equity (e.g., cash used to buy other securities) and would like his/her portfolio diversified in the same percentages as the existing members. Accordingly, each of the existing members “sells” 166.65 IBM shares to the new member for $10,000. This leaves each of the original members with 333.3 shares of IBM and $10,000 in other equity (e.g., shares in other securities purchased using new member's money). The new member also has 333.3 shares of IBM (166.65 from each of the original two members) and $10,000 in other equity (for a total contribution of $30,000). After some period of time, the market price for IBM increases to $70 per share as indicated in block 608. As a result, each member now has $33,333 in equity.

At this point in time, a fourth member is added as indicated in block 610. The fourth member is willing to contribute $16,666 in equity and would like his/her portfolio diversified in the same percentages as the existing members. Accordingly, each of the existing members “sells” 47.63 IBM shares to the new member for $3,333. This leaves each of the original members with 285.7 shares of IBM and $13,333 in other equity. The new member has 142.9 shares of IBM (47.63 from each of the three members) and $6,666 in other equity (for a total contribution of $16,666). After some period of time, the market price for IBM increases to $80 per share as indicated in block 612. As a result, each of the first three members now has $36,190 in equity, and the fourth member has $18,095 in equity.

Subsequently, the fourth member leaves the investment group as indicated in block 614. Because the cost basis of each individual member was tracked, the fourth member pays the appropriate amount of tax on his/her realized gains. Specially, in this example, the fourth investor is liable for $1,429 in gains because he/she “sold” 142.9 shares of IBM at $80 per share with a cost basis of $70 per share. This leaves the remaining three members in a equitable position as if the fourth member had not left.

In summary, persons of ordinary skill in the art will readily appreciate that methods and apparatus for managing and reporting on a plurality of individual investments in a pooled investment group have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

1. A method of tracking a plurality of investments, the method comprising:
storing accounting data associated with a plurality of members in an investment group;
storing data indicative of adding a new member to the investment group, wherein the new member is added to the investment group on a first date;
retrieving a first market price associated with a security held by the investment group and associated with the first date;
storing data indicative of a first cost basis adjustment in response to adding the new member, wherein the first cost basis adjustment is based on the first market price;
calculating a tax liability for each of the plurality of members that is based on the data indicative of the first cost basis adjustment; and
generating a report based on the data indicative of the first cost basis adjustment.

2. The method of claim 1, further comprising:
storing data indicative of removing at least one of the plurality of members; and;
storing data indicative of a second cost basis adjustment in response to removing the at least one member.

3. The method of claim 2, wherein the at least one member is removed from the investment group on a second date, the method further comprising retrieving a second market price associated with the security held by the investment group and associated with the second date, wherein the second cost basis adjustment is based on the second market price.

4. The method of claim 1, wherein the report is a data file used to import data from one software program into another software program.

5. A method of tracking a plurality of investments for an investment group, the method comprising:
storing a first account record including first investor identification data, first security identification data, first security quantity data, and first security cost basis data;
tracking investment information on an individual investor basis for a plurality of investors of an investment group, wherein each investor in the investment group is associated with an adjusted cost basis;
combining the individual investment information for the plurality of investors; and
providing investment information on the investment group based on the combined individual investment information.

6. The method of claim 5, further comprising combining the investment information for a plurality of transactions for an individual investor without including investment information of other individual investors.

7. The method of claim 5, further comprising tracking investment information for each individual investor in a sub-account.

8. A method of managing a plurality of investments, the method comprising:
recording data indicative of a first investor identity;
recording data indicative of a second investor identity, the first investor identity being different then the second investor identity;
associating data indicative of a first number of shares of a first marketable asset with the data indicative of the first investor identity;
associating data indicative of a second number of shares of the first marketable asset with the data indicative of the second investor identity, the second number of shares divided by the first number of shares defining a first ratio;
associating data indicative of a third number of shares of a second marketable asset with the data indicative of the first investor identity, the second marketable asset being different then the first marketable asset;
associating data indicative of a fourth number of shares of the second marketable asset with the data indicative of the second investor identity, the fourth number of shares divided by the third number of shares defining a second ratio, the second ratio being different than the first ratio;
selling the first number of shares of the first marketable asset and the second number of shares of the first marketable asset together as a first pooled group; and
purchasing a fifth number of shares of a third marketable asset and a sixth number of shares of the third marketable asset together as a second pooled group, the third marketable asset being different than the first marketable asset, the sixth number of shares divided by the fifth number of shares defining a third ratio, the third ratio being equal to the first ratio.

9. The method of claim 8, further comprising selling the fifth number of shares of the third marketable asset without selling the sixth number of shares of the third marketable asset.

10. The method of claim 8, wherein recording data indicative of the first investor identity comprises storing at least one of a name and an account number in a relational database.

11. The method of claim 8, wherein associating data indicative of the first number of shares of the first marketable asset with the data indicative of the first investor identity comprises storing at least one of a name and an account number in association with a securities identifier in a relational database.

12. The method of claim 11, wherein the securities identifier comprises a stock symbol.

13. The method of claim 8, wherein selling the first number of shares of the first marketable asset and the second number of shares of the first marketable asset together as the first pooled group comprises selling via a third party money manager, wherein the third party money manager is unaware of the first number and the second number.

14. The method of claim 13, wherein purchasing the fifth number of shares of the third marketable asset and the sixth number of shares of the third marketable asset together as the second pooled group comprises purchasing via the third party money manager, wherein the third party money manager is unaware of the fifth number and the sixth number.

15. A system for managing a plurality of investments comprising:
a data standardization server coupled to a network for producing standardized data based on a plurality of uploaded investment transaction data;
a first custodian server coupled to the network, wherein the first custodian server uploads first investment transaction data to the data standardization server in a first format;
a second custodian server coupled to the network, wherein the second custodian server uploads second investment transaction data to the data standardization server in a second format, the second format being different than the first format; and
a tracking server coupled to the network, wherein the tracking server receives the standardized data from the data standardization server, updates a plurality of sub-accounts associated with an investment group, produces a report associated with the investment group, and produces a report associated with each sub-account.

16. The system of claim 15, wherein the tracking server includes the data standardization server.

17. The system of claim 16, wherein the tracking server includes the first custodian server and the second custodian server.

18. The system of claim 15, wherein the first custodian server is associated with a first bank and the second custodian server is associated with a second bank.

19. The system of claim 15, wherein the tracking server receives non-standardized data from a third custodian server.

20. The system of claim 15, wherein the tracking server stores data indicative of a cost basis adjustment for each sub-account.

21. A computer readable medium storing instruction structured to cause at least one computing device to:
store accounting data associated with a plurality of members in an investment group;
store data indicative of adding a new member to the investment group;
store data indicative of a first cost basis adjustment for the plurality of members in response to adding the new member; and
calculate a tax liability for each of the plurality of members that is based on the data indicative of the first cost basis adjustment.

22. The computer readable medium of claim 21, wherein the new member is added to the investment group on a particular date, the instructions being structured to cause the computing device to retrieve a market price associated with a security held by the investment group and associated with the particular date, wherein the first cost basis adjustment is based on the market price.

23. The computer readable medium of claim 21, wherein the instructions are structured to cause the computing device:
store data indicative of removing at least one of the plurality of members; and;
store data indicative of a second cost basis adjustment in response to removing the at least one member.

24. The computer readable medium of claim 23, wherein the at least one member is removed from the investment group on a particular date, the instructions being structured to cause the computing device to retrieve a market price associated with a security held by the investment group and associated with the particular date, wherein the second cost basis adjustment is based on the market price.

25. The computer readable medium of claim 21, wherein the instructions are structured to cause the computing device to generate a report based on the data indicative of the first cost basis adjustment.

26. The computer readable medium of claim 25, wherein the report is a data file used to import data from one software program into another software program.
